(19) United States
(12) Patent Application Publication
(10) Pub. No.: US 2019/0251607 A1
(43) Pub. Date: Aug. 15, 2019

(54) Fuel Tax Revenue and Retail Data Collection System and Method

(71) Applicant: True Group Inc., Oak Brook, IL (US)

(72) Inventors: Brian J. Salerno, Hinsdale, IL (US); Doug Rodewald, Saugatuck, MI (US)

(21) Appl. No.: 16/275,962

(22) Filed: Feb. 14, 2019

Related U.S. Application Data
(60) Provisional application No. 62/630,604, filed on Feb. 14, 2018.
(60) Provisional application No. 62/641,495, filed on Mar. 12, 2018.

(51) Int. Cl. G06Q 30/02; H04W 4/40; H04L 29/08; H04W 4/02; H04W 24/08; G06Q 30/04

(52) U.S. Cl. CPC G06Q 30/0284; H04W 4/40; H04L 67/306; H04W 88/08; H04W 24/08; G06Q 30/04; H04W 4/023

(57) ABSTRACT

The system of the present invention includes at least one access point, and a vehicle communicable with the access point. The system also includes a vehicle data extractor communicable with the access point for extracting vehicle data from the vehicle, the vehicle data including vehicle mileage, and a tax calculator for calculating a mileage-based tax amount using the extracted vehicle mileage data.

### RELATED APPLICATIONS

The present application claims priority to U.S. Provisional Patent Application No. 62/630,604, titled “Fuel Tax Revenue and Data Collection System and Method,” filed on Feb. 14, 2018, and to U.S. Provisional Patent Application No. 62/641,495, titled “Retail Data Collection System and Method” filed on Mar. 12, 2018. The '604 and '495 applications are both incorporated herein by reference in their entirety.

### TECHNICAL FIELD OF THE INVENTION

The present invention relates to collecting and presenting analytical data that can be used in a variety of industries and applications including but not limited to general retail, restaurants, fuel retail, convenience store, and automotive. The present invention also relates to the various data elements that are collected from vehicles related to mileage and correlate to a fuel or convenience sale at a point of sale.

### BACKGROUND OF THE INVENTION

Fuel taxes are generally currently collected based on a per-gallon rate for each gallon of fuel sold at the pump. Due to the increased fuel efficiency of modern cars and the introduction of electric vehicles (EV's), less fuel is being sold while more miles are being driven, and therefore, less taxes are being collected with the same or more infrastructure maintenance required. To counter the reduced volume of fuel sold, and thus the reduced tax revenue, the present invention provides a system and method whereby fuel taxes and other data are collected on a per-mile driven basis.

In addition, many businesses have differing technologies that implement their point of sale, customer loyalty, or other business intelligence systems to maximize customer service as well as enhance business performance. The data collection system and method also provides the ability to link retail technology assets, including point of sale data, customer relationship management, network based customer location data and loyalty/reward systems, as well as other business intelligence systems to identify trends, anomalies, unique customers or devices or engage a transaction. Sample transactions include a purchase, a reward delivery, a reward redemption, an application of a tax or an incremental charge or the delivery of a message.

### SUMMARY OF THE INVENTION

There is disclosed herein an improved infrastructure tax collection and payment system and method which avoids the disadvantages of prior systems such as taxing only based on fuel consumption while affording additional operating advantages such as taxing based on usage of the infrastructure or providing incentives to use the infrastructure differently.

The present invention also provides the ability to collect tax revenue on a mileage basis, as well as collect additional data at the point of sale and from vehicles.

The present invention further provides the ability to link retail technology investments, including point of sale data, operational analytics, addressable market engagement, customer relationship management and customer loyalty systems, as well as other business intelligence systems to further improve the infrastructure tax collection process.

In an embodiment, the system of the present invention includes at least one access point, and a vehicle communicable with the access point. The system also includes a vehicle data extractor communicable with the access point for extracting vehicle data from the vehicle, the vehicle data including vehicle mileage, and a tax calculator for calculating a mileage-based tax amount using the extracted vehicle mileage data.

In another embodiment, the present invention describes a method for mileage-based tax collection at a vehicle fuel facility. The method includes the steps of extracting mileage data from a vehicle, and calculating a mileage-based tax based on the extracted vehicle mileage data.

In a further embodiment, the present invention describes a system for retail data collection. The system includes a user communication device having a signal, and at least one access point communicable with the user communication device. The access point is able to access and determine signal strength data from the mobile device. The system also includes a data storage device for storing the signal strength data over time, and a signal strength data analyzer for analyzing the signal strength data to determine a user's relative location within a defined area over time.

In a still further embodiment, the present invention provides a method for retail data collection. The method includes the steps of providing a user a communication device with a signal, communicating the signal strength data to at least on access point, and using the signal strength data to determine the user's relative location within a defined area over time.

These and other aspects of the invention may be understood more readily from the following description and the appendices.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a schematic of an infrastructure tax revenue and retail data collection system in accord with an embodiment of the present invention.

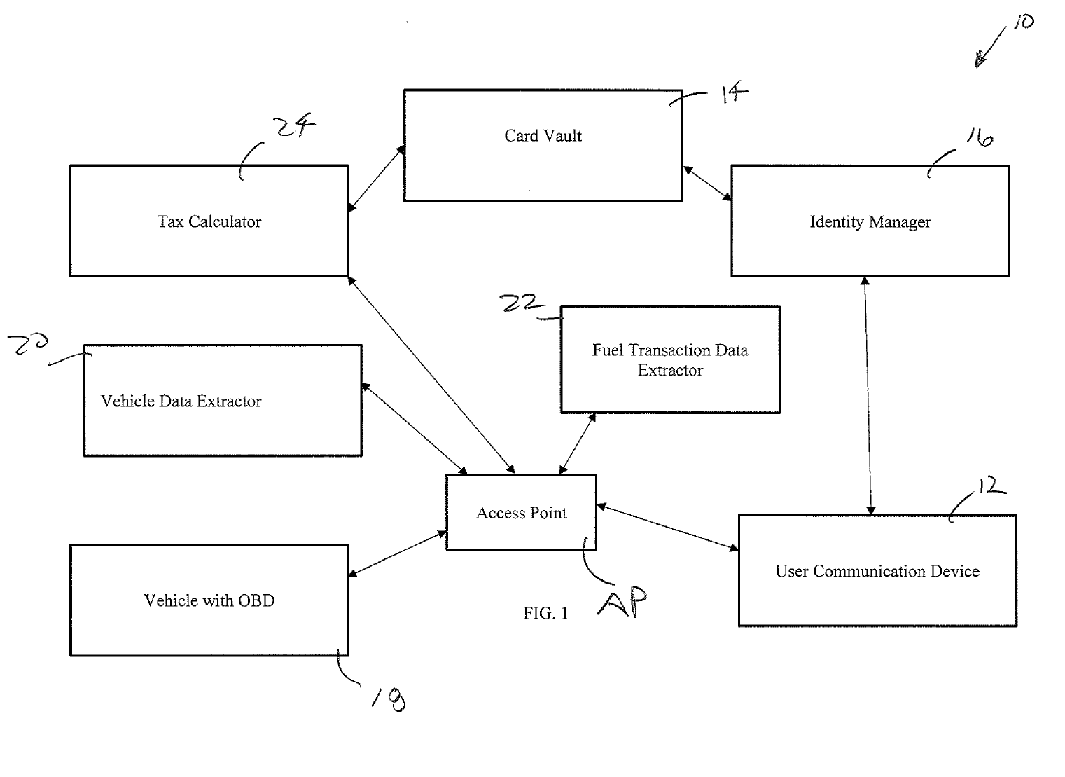

FIG. 2 is a schematic of an infrastructure tax revenue and retail data collection system in accord with an embodiment of the present invention.

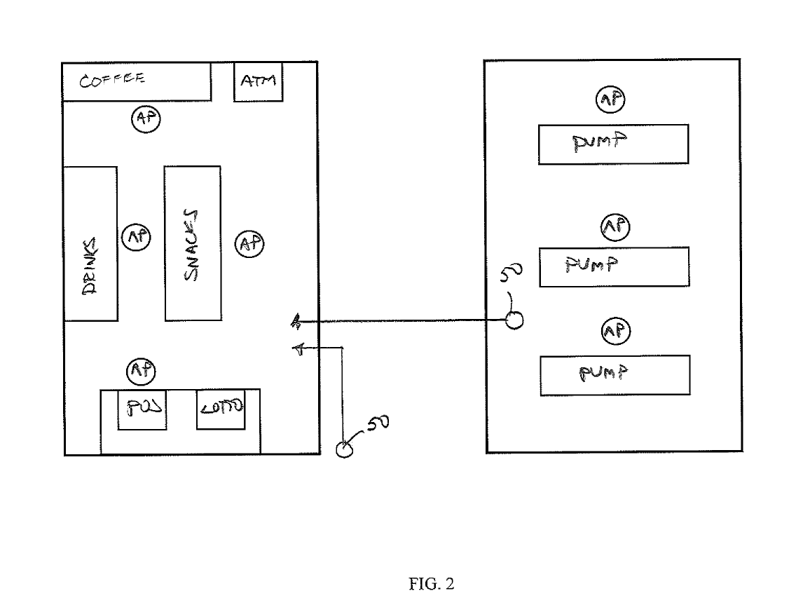

FIG. 3 is a schematic of an infrastructure tax revenue and retail data collection system in accord with an embodiment of the present invention.

FIG. 4 is a schematic of an infrastructure tax revenue and retail data collection system in accord with an embodiment of the present invention.

FIG. 5 is a process drawing showing the steps of a schematic of an infrastructure tax revenue and retail data collection method in accord with an embodiment of the present invention.

FIG. 6a is a process drawing showing the steps of a schematic of an infrastructure tax revenue and retail data collection method in accord with an embodiment of the present invention.

FIG. 6b is a process drawing showing the steps of a schematic of an infrastructure tax revenue and retail data collection method in accord with an embodiment of the present invention.

FIG. 7 is a process drawing showing the steps of a schematic of an infrastructure tax revenue and retail data collection method in accord with an embodiment of the present invention.

FIG. 8 is a process drawing showing the steps of a schematic of an infrastructure tax revenue and retail data collection method in accord with an embodiment of the present invention.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

In an embodiment, there is shown and described an infrastructure tax revenue and data collection system and method that provides the ability to collect tax revenue on a mileage basis at the point of sale, as well as collects additional data from the driver or vehicle at the point of retail sale. Specifically, the car will transmit its current mileage to a cloud-based tax system via an access point located at the site. The system will then extract the amount of fuel purchased from the fueling center's point of sale (POS) system and enable the cloud services to determine how much total tax should be applied to the vehicle. The system will then calculate the difference between the tax that is applied to the fuel purchase vs. the total infrastructure tax, the net difference will then either be applied to the current purchase, will be allowed to be paid via cash inside or will be sent via a secondary transaction such as an invoice to the consumer via a card on file. Payment of the incremental or fuel infrastructure tax will flow as follows for the pay at the fuel pump embodiment, and is more fully explained below. This flow also is used for paying the tax either inside the facility as a point of sale transaction or via a retailer's mobile wallet.

Settlement of the transaction will then be sent to the fuel facility or a centralized entity, who then disburses funds in the amount of the calculated tax to the identified authority. This disbursement can be at an agreed upon frequency, such as immediately, or on a daily, weekly, or monthly basis. Alternatively, payment of the calculated tax for the fuel transaction can be transmitted to the taxing body via a standard card or a digital payment form such as PayPal, Venmo or Zelle.

In an embodiment, to use the system, a user will register to create an account. That account will hold certain user information stored in a user profile. The user profile can include information such as name, address, and credit card information. The user information can also include information on past purchases, access to offers, a messaging system, and vehicle data such as VIN number, license plate number, make, model, and the like. The user profile will continually be updated as the user makes additional purchases, travels to different locations, provides additional profile detail, and the like.

The user's credit card information will stored within a card acquirer's card vault 14. The acquirer's card vault 14 stores information provided by the user in connection with his or her payment account. The user's profile information will be stored within an identity management host 16. The identity management host 16 will gather all non-card related activities, transactions, rewards, third party offers, segmentation, campaigns, and the like. The user's credit, debit, gift or proprietary card and other identifying information such as name, address, is registered via a secure inline frame or iframe to the identity management host 16. A token containing the user information is provided to the host 16 to maintain this information. When a user is identified as being present at the facility, the identity host 16 will send the stored token with the user identifying information to the acquirer. The card vault acquirer 14 uses the information stored in the token to initiate a card not present transaction.

As shown in the FIGS., the infrastructure tax revenue system 10 includes a user having an identification device 12. The identification device 12 can be a cell phone, a smartphone, a tablet, an onboard device (OBD device) on the vehicle, a smart vehicle, or other such personal electronic device. The device 12 preferably has wi-fi access or blue tooth enabled. The user identification device 12 is connectable to an access point AP to collect the cars mileage and any other relevant information needed to calculate the infrastructure tax.

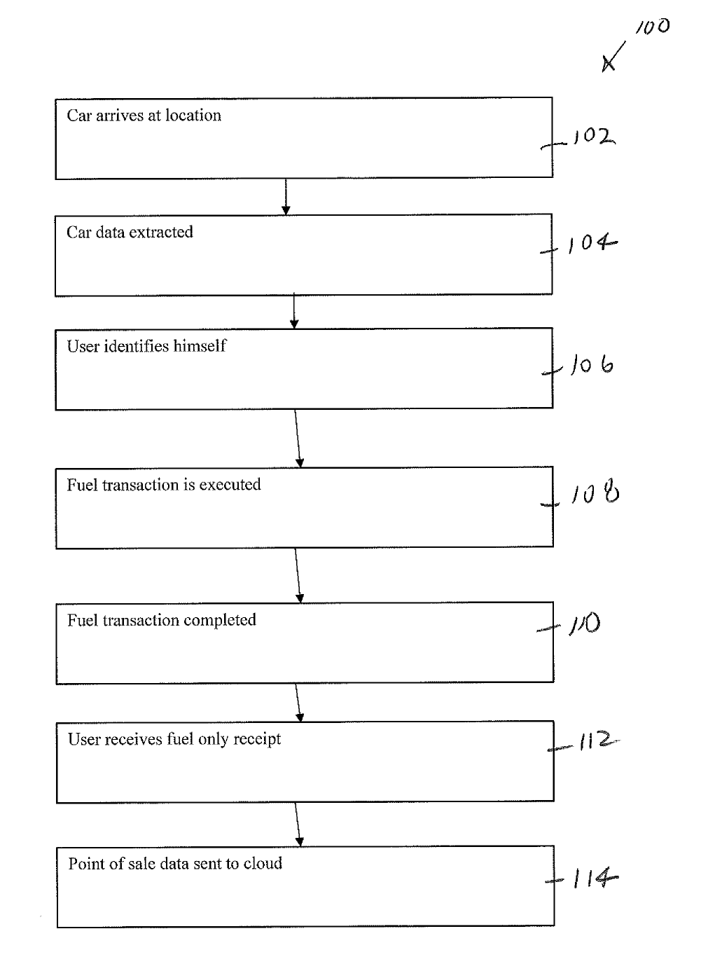

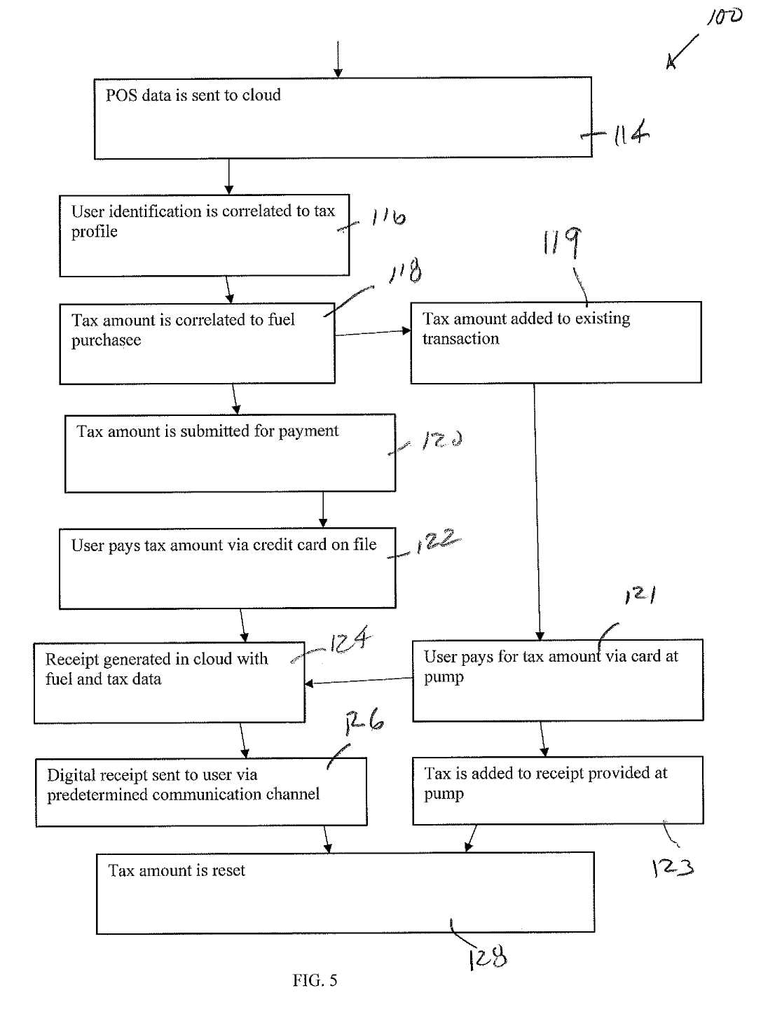

In an embodiment where a user has a registered account, and pays either at the pump, an electric vehicle charging station, or inside the fuel facility via the registered account (FIGS. 4 and 5), the system 10 and method 100 operate as follows. A user and his or her vehicle 18 arrives at a retail gas station 102 with an identification device 12. Car data, such as make, model, license plate number, VIN number, and mileage are extracted via a vehicle data extractor 20 via a vehicle identifier or ODM device associated with the vehicle 104 and an access point AP located at the facility. A user logs into his or her account to verify his or her identity 106. In a preferred embodiment, the vehicle identifier will communicate with a wireless network its vehicle information via the Zigbee wireless protocol. Also in an embodiment, the user will be identified at the fuel facility via a key code entered by the user at the facility, either at the fuel pump or inside the facility, for example, via a pin number. Alternatively, the user will be identified via a beacon or authenticated mobile wallet from an app on the identification device 12. The user executes 108 and completes a fuel transaction 110, and receives a fuel only receipt 112 from the outside payment terminal or OPT. Point of sale data relating to the fuel transaction is sent to the cloud 114 via a fuel transaction data extractor 22. The user identification information is correlated to the user's tax profile 116. A taxed amount determined via a tax calculator 24 and the taxed amount and the fuel transaction is linked to the fuel purchase 118. The taxed amount is submitted to the taxing body 120 via the credit card information in the user's profile 122 or the tax is added to the at POS transaction 119 and the tax is paid by the user at the time the user pays for the fuel purchase at the pump with their payment card 121. After the fuel purchase, the tax would be added to the receipt received at the pump 123. Additionally, for the flow in which the user pays with a card on file or in the case in which the user has elected to receive a digital receipt, a receipt is generated in the cloud with fuel and tax data 124, and sent to the user via the user's predetermined selected communication channel, including email, text, voice message, or other suitable means 126. The taxed amount is reset in preparation for the next fuel transaction 128.

In the embodiment where a user uses a digital device located at the fuel facility as opposed to at the pump, the flow is generally as follows. When using the digital device, the user identifies they are at the correlating pump by the POS's required method. The fuel purchase is then initiated. While the fuel purchase is initiated, the vehicles mileage data is sent to the infrastructure tax host or tax calculator 24 via the access point AP as described above. When the fuel purchase is completed, the POS sends the total amount paid in fuel tax to the host and the host calculates the net difference between the amount owed and collected. The net amount is then sent to the card acquirer to initiate the payment and send a digital receipt to the mobile device either directly or via the fuel retailers preferred mobile provider. The fuel facility pays the fuel tax calculated from the transaction to the taxing body on an agreed upon schedule, such as daily, weekly, etc. The fuel facility report to the taxing body, also on an agreed upon schedule to ensure proper payment of taxes.

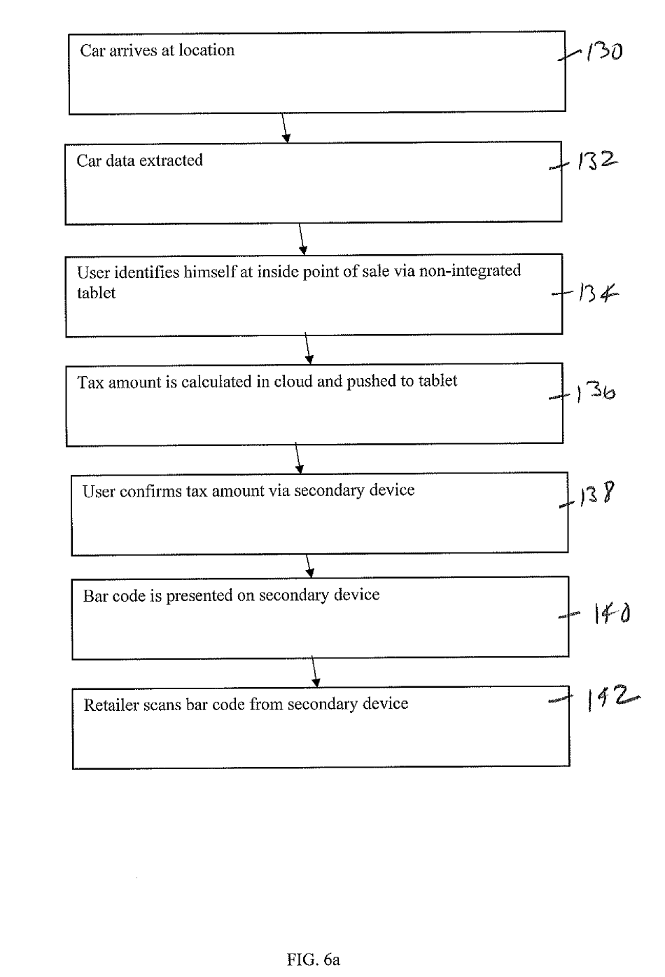

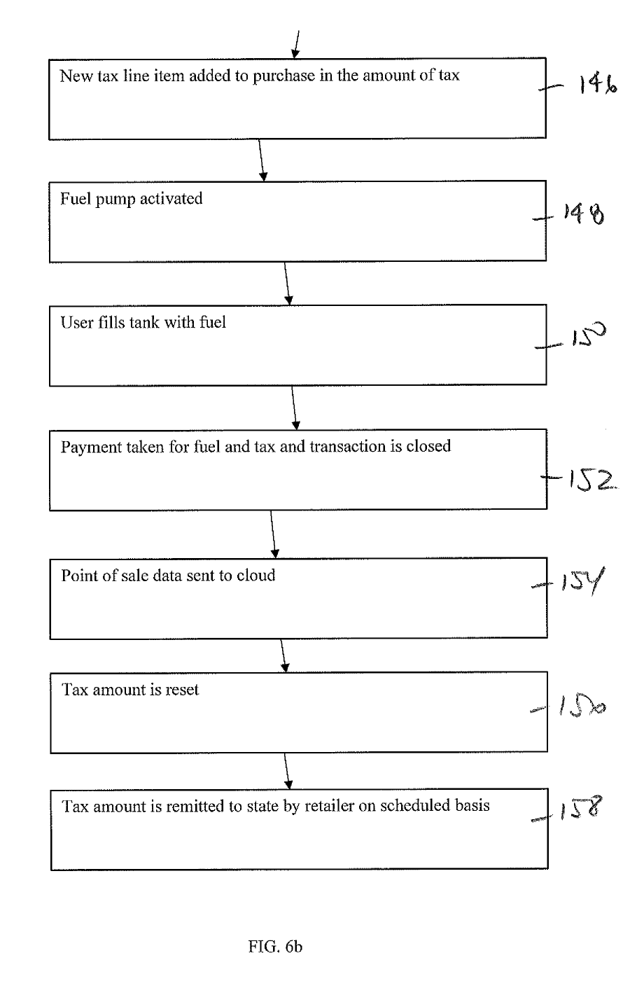

In the embodiment where a user is paying for fuel inside a fuel facility by a credit card or cash instead of a registered account (FIGS. 6a and 6b), the system 10 and method 100 operate as follows. The user and his car arrive at the location of the fuel facility 130. Car data, such as make, model, license plate number, VIN number and mileage are extracted via an ODM device associated with the vehicle 132. The user identifies himself or herself at the point of sale via a secondary device such as a tablet 134. A tax amount is calculated in the cloud and pushed to the tablet 136 via a taxed amount identifier such as a bar code. The user receives and confirms the taxed amount via that secondary device 138. The bar code with the tax information is presented on the secondary device 140. The user presents the bar code to the attendant at the facility, who scans a bar code from the secondary device 142. The taxed amount is added to the fuel purchase amount at the register 146. The fuel pump is activated 148, and the user fills his fuel tank to the desired level 150. Payment is taken for the fuel and tax and the transaction is closed 152. This completes the fuel purchase transaction. The point of sale information is sent to the cloud to reset the tax 154, while indicating a non-account payment. The taxed amount is reset 156. The taxed amount is sent to the taxing body by the facility or the oil company on a scheduled basis 158 as set by the taxing body, be it daily, weekly, monthly, etc.

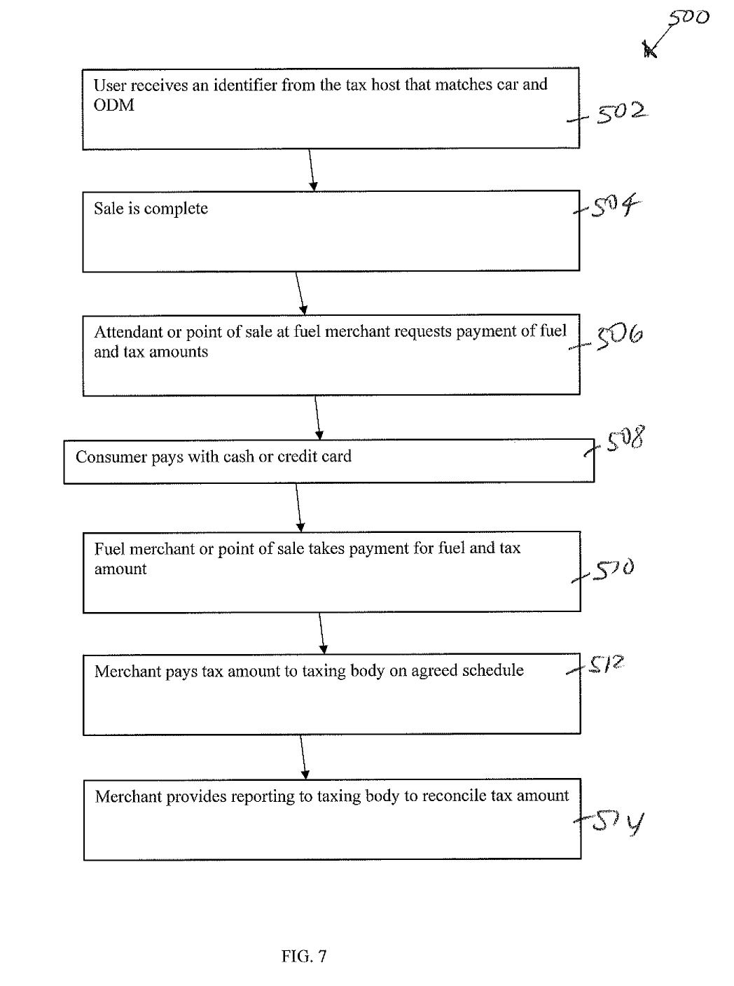

In an embodiment shown in FIG. 7, where the mileage-based tax is paid via the fuel facility, or its designees' payment network or a cash receipt, the system 10 method 500 include the user receiving an identifier from the taxing host an identifier that matches the user's vehicle and the vehicle's ODM 502. The fuel sale completes 504 with the user paying via credit card or cash for the fuel, the fuel tax, and the mileage-based tax amounts to the fuel facility 506, 508, 510. The fuel facility pays the mileage-based tax and the fuel purchase tax to the taxing body on an agreed upon schedule 512. The merchant reports to the taxing body to reconcile the tax amount 514.

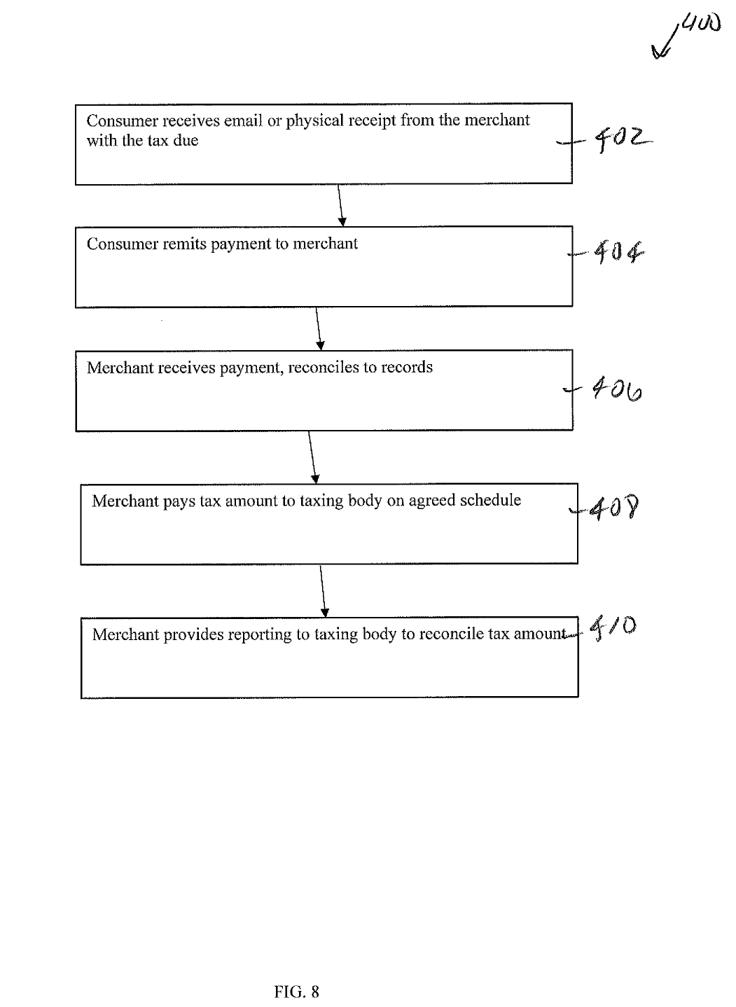

In an embodiment shown in FIG. 8, where the user pays the taxed amount via an invoice, a user is invoiced for the tax after purchasing fuel based on their miles driven. The user receives from the fuel facility or electric charging company either a physical or electronic invoice with the tax amount owed. The user remits the tax payment to the taxing body via credit card, check or other payment method. The facility receives payment from the user, reconciles the payment to its records for the user's, and submits the payment to the taxing body. Alternatively, the taxing body may invoice the user and receive payment from the user.

In this embodiment 400, the user need not have any stored credit card information, nor would the user need to pay the tax inside the fuel facility. The user would receive an invoice to his or her registered address at a desired frequency, such as monthly 402. The invoice could list data from fuel purchases at facilities or electric charging systems that participate in the program so the user could verify such purchases and tax calculations. The customer remits payment for the fuel or any costs related to the electric charging and the taxable amount to the fuel merchant 404. The merchant receives the payment, reconciles the fuel or any charges related to electric charging and tax payment to its records 406. The merchant pays the tax to the taxing body on an agreed schedule 408. The merchant would also report to the taxing body the sale so the taxing body could reconcile the tax amount 410.

In another embodiment, the data collection system of the present invention provides a method to collect data on the behavior of customers, and measure the effectiveness of marketing measures and programs on customers. The retail system also allows retailers to measure the impact of investments they have made in marketing efforts. The invention integrates various inputs such as marketing programs and loyalty in determining those marketing efforts' efficacy.

In this embodiment, a user is tracked, preferably using a mobile device such as a mobile phone. The mobile device pings and communicates with an access point (AP) or access points (AP's) located throughout a retail or other location at desired spots. The AP's and are placed at specific locations depending on the desired information or user flows that the system is intended to collect. The system tracks users based on their media access control (MAC) addresses and is able to segment and quantify users based on the strength of the signal (received signal strength indicator or RSSI) from the device to the AP. The system stores and uses the strength of signal and relationship to other placed AP's to identify the location, duration and other analytic information related to the user.

In this embodiment, the system will also use device specific information such as type of device, manufacturer and black list (does the device belong to an employee) to determine if the user should be used in any desired analytics. The user can be anonymous or known. To become known, the user authenticates himself or herself via access to the retailer's network, such as via a splash page. In the case the user is known, incremental device and profile information may be appended to the base device information as the user makes incremental purchases, registers for loyalty programs or engages in other experiences (car wash).

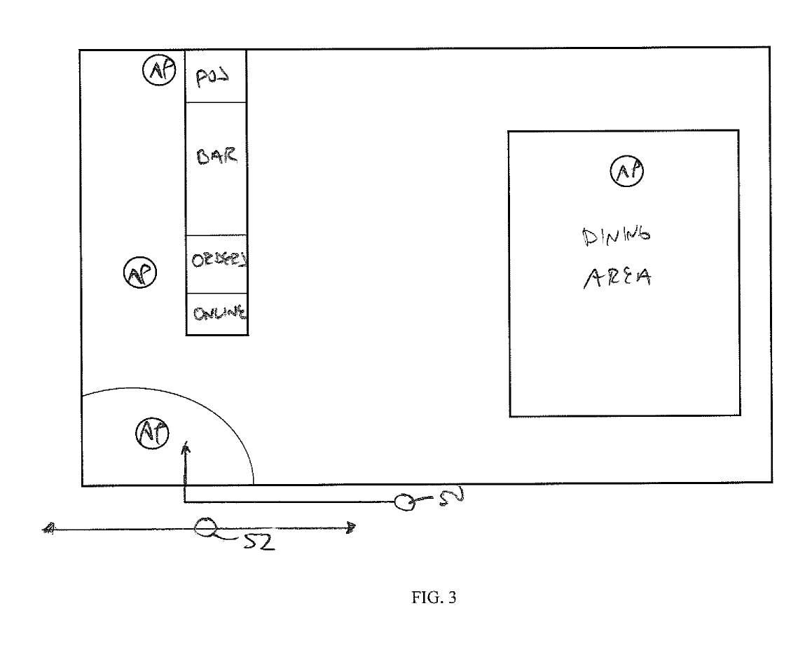

For example, in an embodiment 200 within a typical gasoline service station as shown in FIG. 3 several access points designate by the prefix “AP” are placed at various locations within the facility. A customer 50 enters the facility with a mobile device with wi-fi access turned on. The customer's device communicates with the access points to track the customer's whereabouts within the facility. Measurables such as the customers time inside the facility, total time at the drink station, snack area, point of sale location, can be determined. Additionally, the system can determine the number of customers that have passed by or visited such areas with the location, the time those customers spent inside the location before going to the point of sale location, and the time the customer spent waiting at the point of sale location.

In addition, in the gas station example 200, measurables can include the amount of time a customer spent at the fuel pumps, and the amount of time spent actually pumping fuel. The system can also determine whether the customer entered the facility, for example, to purchase convenience store items, and once inside the facility, the customer 50 could be tracked as indicated above. The above measurables could be analyzed to produce marketing information that can be used to the system employer's desires.

In an example using a restaurant shown in FIG. 4, the system 300 can include access points AP located in the dining area, at the bar, at the point of sale, at the order placement counter. These access points could provide measurables that could include wait time for a customer 50 to place an order, wait time between placing the order and paying for and receiving the order, as well as dine in time, and total duration of a customer's visit. For online orders, measurables could include the time from online order to customer pickup of the order. An access point placed near the door or in another position could obtain measurables as the foot traffic passing the restaurant denoted by the customer 52. The information could also include frequency of particular customers' visits to the facility.

This information will allow one employing the system of the present invention to obtain a baseline of actual customer and potential customer activity and to develop customer engagement strategies custom to its particular business with limited capital investment based on frequency, dwell time, time of visit and other location and time qualifications. The system is scalable, modular and can be meshed together. These system characteristics thus allow the system to be deployed to small or large venues such as concerts, city or township events, in hotels, and other venues where one might wish to track customer data and movement to be able to focus marketing to actual customer data.

The system of the present invention allows retailer users of the system to determine how it engages the customer, for example, by email, text, through a dedicated app, or a splash page.

The system leverages various disparate data elements to enable analytics across system databases and enable analytics by stitching different data sources together. Further, by using a single SSID (Service Set Identifier) the system of the present invention can identify and track the customer across locations and clients thus unifying all system APs and connecting the users to the same loyalty platform and beacons. The user is thus managed via a single platform which is used across multiple merchants and POS.

Physically, the system integrates various site level and cloud based technologies through API (application program interface) calls which then captures various data elements and collects them into a database. Once that data have been normalized and structured, it can be reported in any specific format per a merchant's specific needs or requirements. The data is primarily cloud based through Azure but can be collected in any data repository. In addition, users with the an application or other interface can interact with event organizers to take surveys, or use event passbooks to denote having attended portions or activities at the event, or raffles.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A system for vehicle mileage-based tax or charge collection at a vehicle fueling facility or via an electronic charging system, the system comprising:
at least one access point;
a vehicle communicable with the access point;
a vehicle data extractor communicable with the access point for extracting vehicle data from the vehicle, the vehicle data including vehicle mileage; and
a tax calculator for calculating a mileage-based tax amount using the extracted vehicle mileage data.

2. The system of claim 1 further comprising:
a fuel purchase data extractor in communication with the fueling facility's point of sale, the fuel purchase data including a fuel purchase amount and a calculated fuel tax amount;

3. The system of claim 1 further comprising:
a user identification device communicable with the access point; and
a user-activated account, the account including a user profile, the user profile communicable with the access point; and
an identity management host for storing the user's profile, and store data related to a user's visits to the fuel facility.

4. A method for mileage-based tax collection at a vehicle fuel facility, the method comprising the steps of:
extracting mileage data from a vehicle; and
calculating a mileage-based tax based on the extracted vehicle mileage data.

5. The method of claim 4 further comprising the step of extracting fuel purchase data, the fuel purchase data including fuel purchase cost and fuel tax amount;

6. The method of claim 4 further including the step of a user paying the mileage-based tax amount and the fuel purchase amount at the vehicle fuel facility.

7. The method of claim 4 further including the step of the fuel facility paying the taxing body the mileage-based tax amount.

8. The method of claim 4 further including the step of the fuel facility invoicing the user for paying the mileage-based tax amount

9. The method of claim 4, wherein the step of extracting vehicle mileage data is performed via an access point located at the vehicle fueling facility.

10. The method of claim 4, wherein the step of extracting vehicle mileage data is performed using device onboard the vehicle.

11. A system for retail data collection, the system including:
a user communication device having a signal:
at least one access point communicable with the user communication device, the access point able to access and determine signal strength data from the mobile device;
a data storage device for storing the signal strength data over time; and
a signal strength data analyzer for analyzing the signal strength data to determine a user's relative location within a defined area over time.

12. The system of claim 11 wherein the user communication device is a mobile telephone.

13. The system of claim 11 further comprising means for communicating with the user.

14. A method for retail data collection, the method comprising the steps of:
providing a user a communication device with a signal;
communicating the signal strength data to at least on access point; and
using the signal strength data to determine the user's relative location within a defined area over time.

15. The method of claim 14 further including the step of using relative signal strength data over time to determine the user's time spent at a particular location within the defined area.

16. The method of claim 14 further including the step of using relative signal strength data over time to determine the frequency of a user's visits to the defined area.

17. The method of claim 14 further including the step of using relative signal strength data over time to determine the number of users who have visited the defined area.

18. The method of claim 14 further including the step of communicating with the user based on a user's particular location within the defined area.

19. The method of claim 14 wherein the defined area is a retail location.

20. The method of claim 14 wherein the defined area is an event venue.
